(19) United States
(12) Patent Application Publication
(10) Pub. No.: US 2014/0052386 A1
(43) Pub. Date: Feb. 20, 2014

(54) Systems and Methods for Handheld Raman Spectroscopy

(71) Applicant: Optopo Inc. d/b/a Centice Corporation, Morrisville, NC (US)

(72) Inventors: Brett Guenther, Cary, NC (US); Scott T. McCain, Durham, NC (US); David J. Brady, Durham, NC (US); Prasant Potuluri, Raleigh, NC (US); Richard Michelli, Raleigh, NC (US)

(73) Assignee: Optopo Inc. d/b/a Centice Corporation, Morrisville, NC (US)

(21) Appl. No.: 13/764,546

(22) Filed: Feb. 11, 2013

Related U.S. Application Data
(60) Provisional application No. 61/597,700, filed on Feb. 10, 2012.

(51) Int. Cl. G01N 21/65

(52) U.S. Cl. CPC G01N 21/65
USPC 702/28

(57) ABSTRACT

A fiber optic input receives light reflected from an unknown compound. An input mask encodes the light received with a one-dimensional input code. A spectral imaging subsystem images the input coded mask and disperses the image. An output mask receives the dispersed image on a row and, at each time step of a plurality of time steps, changes the code of the row to further encode the image. An illumination subsystem collects the additionally encoded light from the row at each time step. A point detector receives the collected light from the illumination subsystem and converts it to an electrical signal at each time step. A memory stores the electrical signal at each time step. A processor calculates a spectral signature for the unknown compound from the electrical signals stored, the one-dimensional input code, and the different additional one-dimensional codes applied.

### CROSS-REFERENCE TO RELATED APPLICATION

This application claims the benefit of U.S. Provisional Patent Application No. 61/597,700 filed Feb. 10, 2012, which is incorporated by reference in its entirety.

### INTRODUCTION

There is a need for a handheld spectroscopy device for the detection of unknown substances. Detection of explosives, for example, is of utmost importance. First responders, warfighters, and screening personnel can all benefit from such a tool. While there are many devices available to detect unknown substances, such as explosives, none of these devices are both inexpensive and ultraportable.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is a flow diagram showing an exemplary design approach, in accordance with various embodiments.

FIG. 3 is a schematic diagram showing a spectrometer in which a slit is replaced with a static coded aperture, in accordance with various embodiments.

FIG. 4 is a table that includes exemplary specifications for a handheld spectroscopy system, in accordance with various embodiments.

FIG. 5 is a table that includes exemplary design requirements for a handheld spectroscopy system that meet the exemplary specifications of FIG. 4, in accordance with various embodiments.

FIG. 6 is a schematic diagram of a coded aperture of a handheld spectroscopy system for detecting unknown substances, in accordance with various embodiments.

FIG. 7 is a schematic diagram of a paraxial model of the imaging spectrometer portion of a handheld spectroscopy system for detecting unknown substances, in accordance with various embodiments.

FIG. 8 is a schematic diagram of a handheld spectroscopy system for detecting unknown substances, in accordance with various embodiments.

FIG. 9 is a schematic diagram showing a series of measurements taken by a handheld spectroscopy system for detecting unknown substances as the output coded mask is moved, in accordance with various embodiments.

FIG. 10 is an exemplary flowchart showing a method for identifying a spectral signature of an unknown substance, in accordance with various embodiments.

FIG. 11 is a schematic diagram of a system that includes one or more distinct software modules that performs a method for identifying a spectral signature of an unknown substance, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DETAILED DESCRIPTION

### Computer-Implemented System

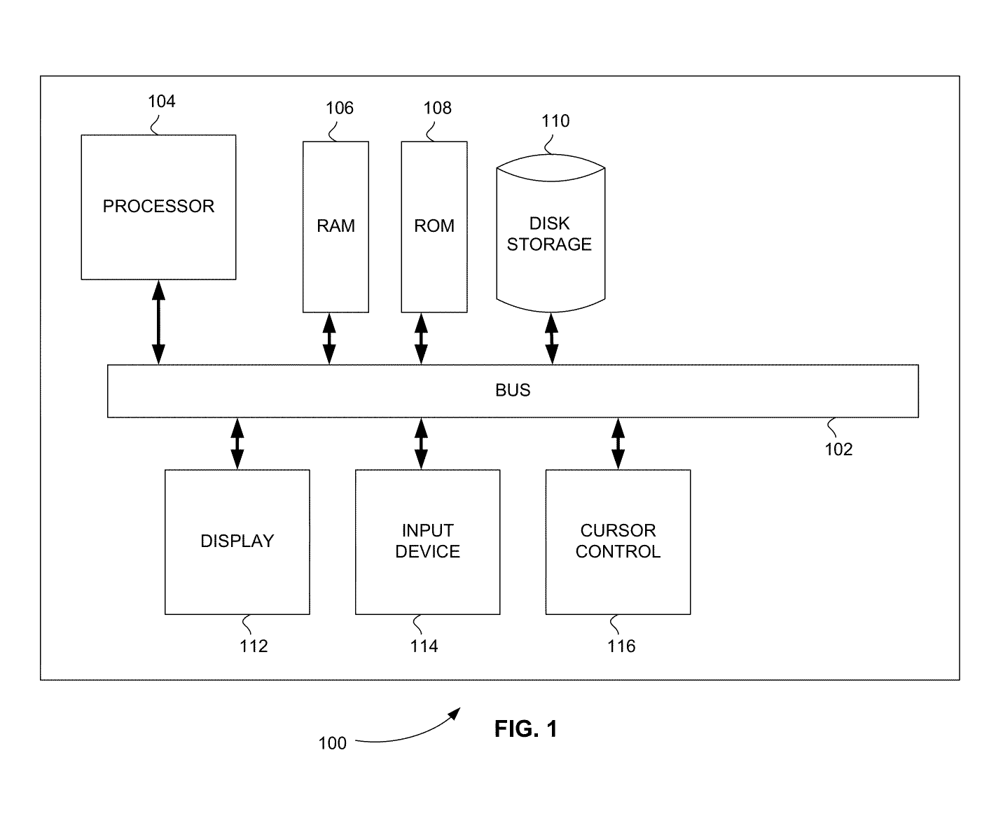

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for determining base calls, and instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively hard-wired circuitry may be used in place of or in combination with software instructions to implement the present teachings. Thus implementations of the present teachings are not limited to any specific combination of hardware circuitry and software.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Systems and Methods for Raman Spectroscopy

As described above, there is a need for a handheld spectroscopy device for the detection of unknown substances. While there are many devices available to detect unknown substances, such as explosives, none of these devices are both inexpensive and ultraportable.

In various embodiments, systems and methods are provided to miniaturize and reduce the cost of a handheld sensor device, such as a 1064 nm Raman spectroscopic sensor. A handheld sensor device can also be referred to as low-cost detection device, palm-size sensor device, classifier, or Raman sensor. In various embodiments, the handheld sensor device has the ability to detect and discern threat targets from a stored database of about 20 compounds. In various embodiments, the palm-sized sensor device has the information-rich benefits of optical, Raman spectroscopy without the drawback of fluorescence interference typical in these targets. In various embodiments, the handheld sensor device is inexpensive resulting from the abundance of 1064 nm excitation sources and due to the single point detector scheme proposed. In various embodiments, acquisition time is minimized through the use of prescreening techniques and/or compressive sampling and adaptive processing.

In various embodiments, a low-cost detection device allows virtually every stakeholder within the public safety and security community to examine suspect material in order to prevent mission failure or loss of life. Such a tiny pocket-sized device is critical to make a negligible impact on the weight carried by the soldiers or first responders.

In various embodiments, the device is small, lightweight, and portable. In various embodiments, the device indicates a target of interest from a library of around 20 or so compounds in a time reasonable in a screening scenario: that is, seconds not minutes. In various embodiments, these 20 compounds are provided or specified at the start of the program. In various embodiments, the sensor has sensitivities and specificities that balance safety with respect for privacy. In various embodiments, the design approach balances cost savings with performance to keep costs in check.

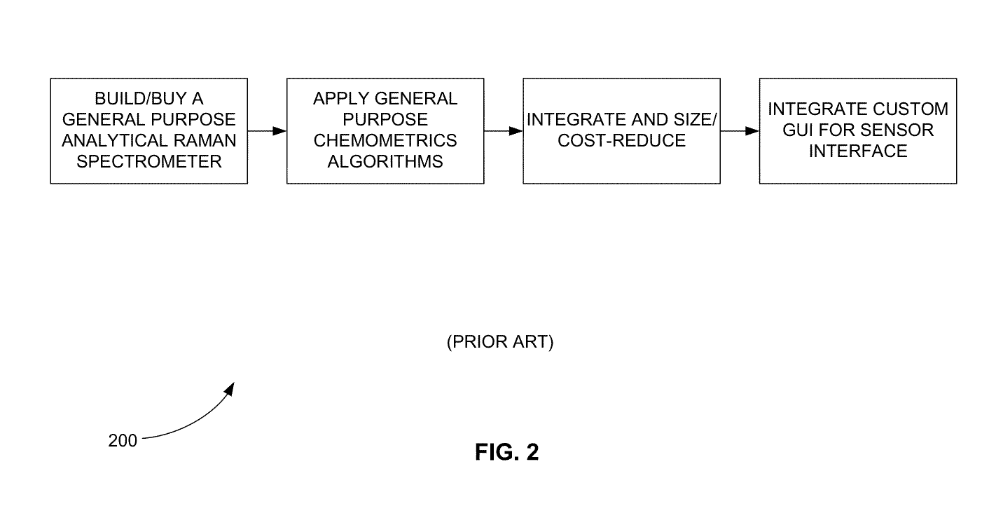

Raman spectroscopy is a great method to measure the fingerprint of a material's molecular structure in a non-contact, non-destructive way. The information obtained from the feature rich spectra can be applied to classifiers with many methods of comparison that are limited by the resolution of the device and the complexity of the algorithms. The typical approach that most researchers take with this type of problem is shown in FIG. 2, which is a flow diagram showing an exemplary design approach, in accordance with various embodiments.

In this typical approach, sensors are built based on Raman spectroscopy and sold to customers that do not know anything about the underlying technology. This compartmentalized and generalized approach works fine for many applications, but starts to run into limitations when trying to create devices that meet extreme and/or very specific requirements. In these cases, the simple approach does not suffice.

In various embodiments, a custom-integrated design approach is used to create systems and methods that meet extreme and/or very specific requirements. Knowing something about the targets of interest is the starting point for such an approach. Through this approach a spectrometer can be designed specifically for these targets. Such a spectrometer might make a terrible analytical device, but would work very well as a special purpose sensor, especially when the hardware limitations are compensated for with custom algorithms. In various embodiments, this approach is coupled with the advantages of coded aperture spectroscopy to create a new Raman sensor in a completely unique way.

Coded aperture spectroscopy is a special brand of computational spectroscopy. In various embodiments, an aperture of the spectrometer is replaced with a code that allows for wavelengths to overlap (multiplex) on the detector. The advantage is similar to Fellgett's advantage found in Fourier Transform systems, but in a much simpler hardware incarnation. In the past, a coded aperture was utilized on the input of the spectrometer to gain throughput without sacrificing resolution.

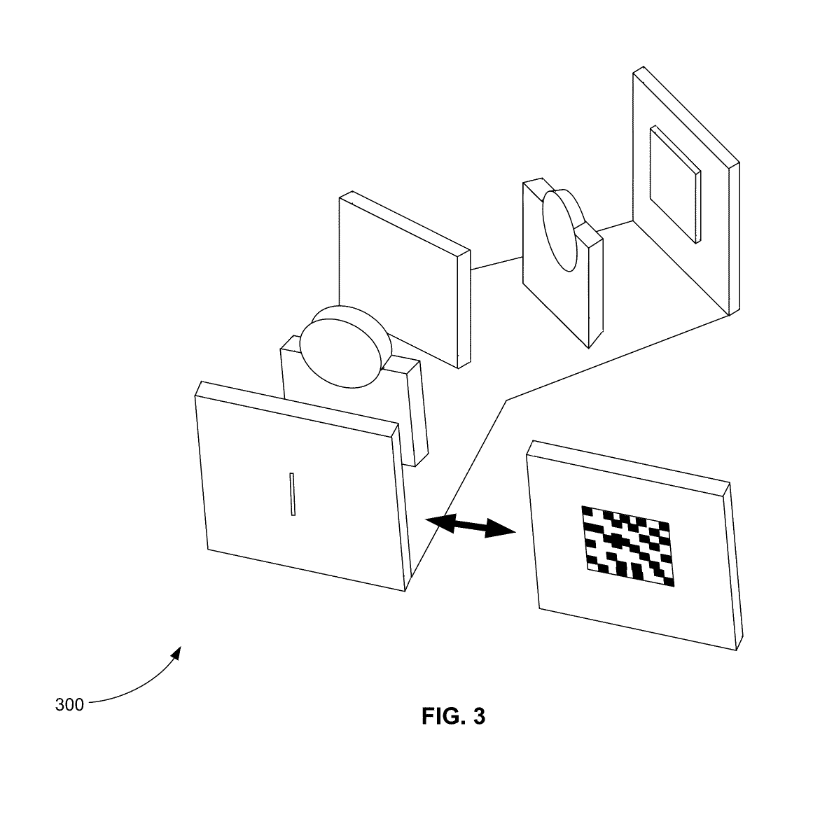

FIG. 3 is a schematic diagram showing a spectrometer 300 in which a slit 310 is replaced with a static coded aperture 320, in accordance with various embodiments. Spectrometer 300 also includes a charged-coupled device (CCD) detector 330.

Coded aperture 320 can be viewed as a collection of coded slits positioned next to one another. In various embodiments, these codes are dispersed and reimaged onto CCD detector 330 and the raw image looks like many overlapping codes (wavelengths are overlapping and sharing detector elements) instead of dispersed slits. Since the code is known apriori, this information is used to reconstruct the original spectrum mathematically. As a result, throughput and field of view for the spectrometer is obtained in a static, robust implementation. Further, the only increased cost of spectrometer 300 is in the mathematical reconstruction performed on a processor, which is inexpensive compared to specialized component costs.

In various embodiments, coded apertures are used at the input and output of the spectrometer to gain several advantages over competing technologies. First, the system benefits from the low noise of a multiplexed scheme (wavelengths sharing a common detector). Next, cost and size are minimized by using an inexpensive single point detector in a wavelength regime. In contrast, array detectors are expensive and bulky. Finally, the decoupling the resolution and the input aperture minimizes the size of the system without sacrificing throughput.

While a Raman signal drops off precipitously as one moves to longer wavelengths, there is still an advantage to moving deeper into the infra-red. The effects of fluorescence, which can normally swamp a Raman spectrum, are all but eliminated above 1000 nm. Unfortunately silicon (Si) detectors lose all quantum efficiency in this wavelength regime, thereby preventing the use of any of the low cost, high performance CCD's developed for the consumer digital photography market. The lowest noise material used as a detector in this region is indium gallium arsenide (InGaAs). This technology lags behind its Si counterpart in both price and performance. Two dimensional InGaAs focal plane arrays cost more than $10,000, while a linear detector array is more than $5000. In addition, the elements in these devices are very large (>25 microns), which limits the focal lengths and dispersion one can use in a traditional spectrometer design.

In various embodiments, a system for Raman spectroscopy that includes a coded aperture at the input and at the output just before a single inexpensive ($100) InGaAs point detector, where all wavelength channels are multiplexed onto a single detector, meets the cost and size requirements for a handheld device. The output code is moved or shifted in order to code all channels, but the advantage again is improved cost and size.

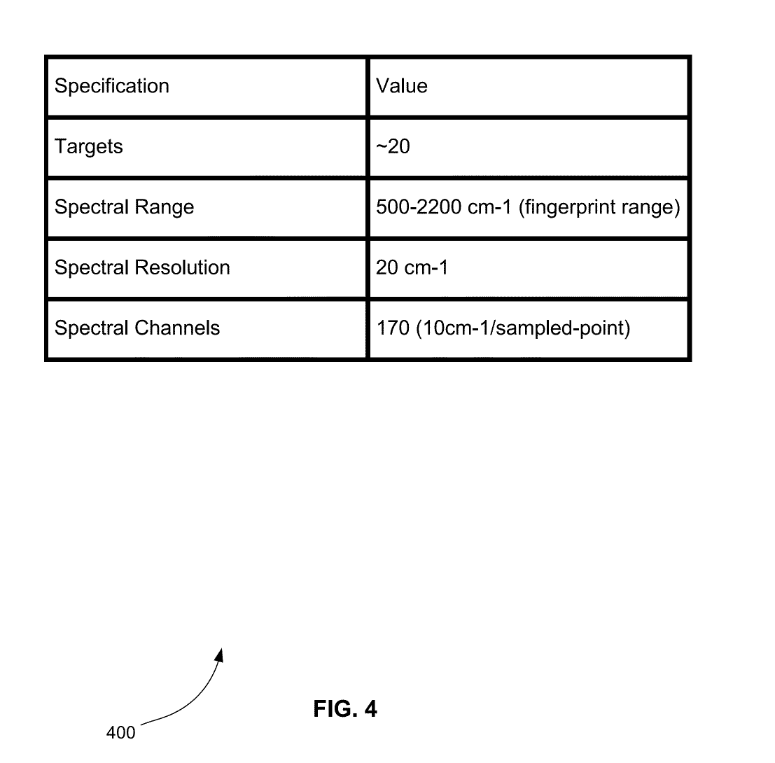

FIG. 4 is a table 400 that includes exemplary specifications for a handheld spectroscopy system, in accordance with various embodiments.

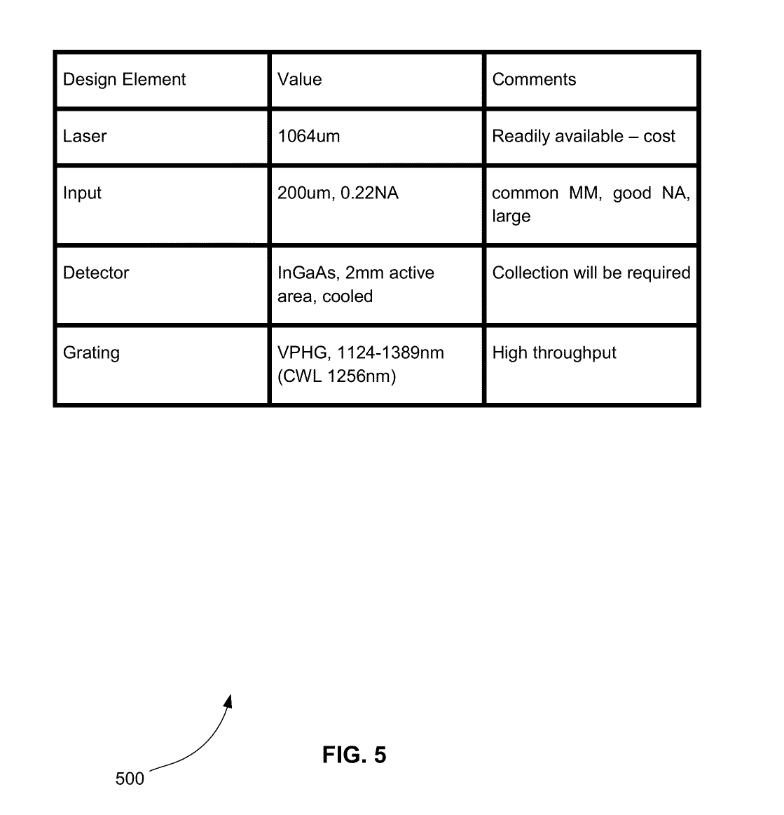

FIG. 5 is a table 500 that includes exemplary design requirements for a handheld spectroscopy system that meet the exemplary specifications of FIG. 4, in accordance with various embodiments.

To keep the system as small as possible, the spectrometer resolution is decoupled from the focal length of the spectrometer lenses. To do this a coded aperture is applied to the input.

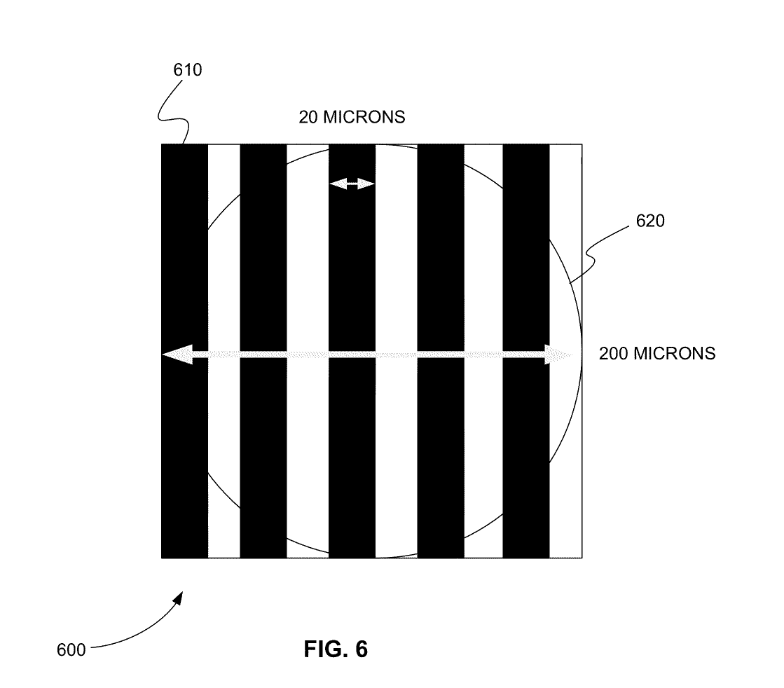

FIG. 6 is a schematic diagram of a coded aperture 600 of a handheld spectroscopy system for detecting unknown substances, in accordance with various embodiments. Here the resolution is set by the smallest element, while the throughput is set by the total open area. To keep the throughput equal to or better than a 50 microns (0.22 NA) fiber, code 610 produces a subaperture that is 20 microns wide. Code 610 is fit directly onto a 200 micron (0.22 NA) fiber 620. This gives about 100 microns of open area illuminated by a slightly smaller fiber area.

In various embodiments, the light from the coded input is dispersed and reimaged in a 1:1 imaging spectrometer. For the output to accommodate 170 channels, for example, the spectrometer's span is set to about 3.4 mm, since the coded input aperture has set the wavelength channel width to be 20 microns.

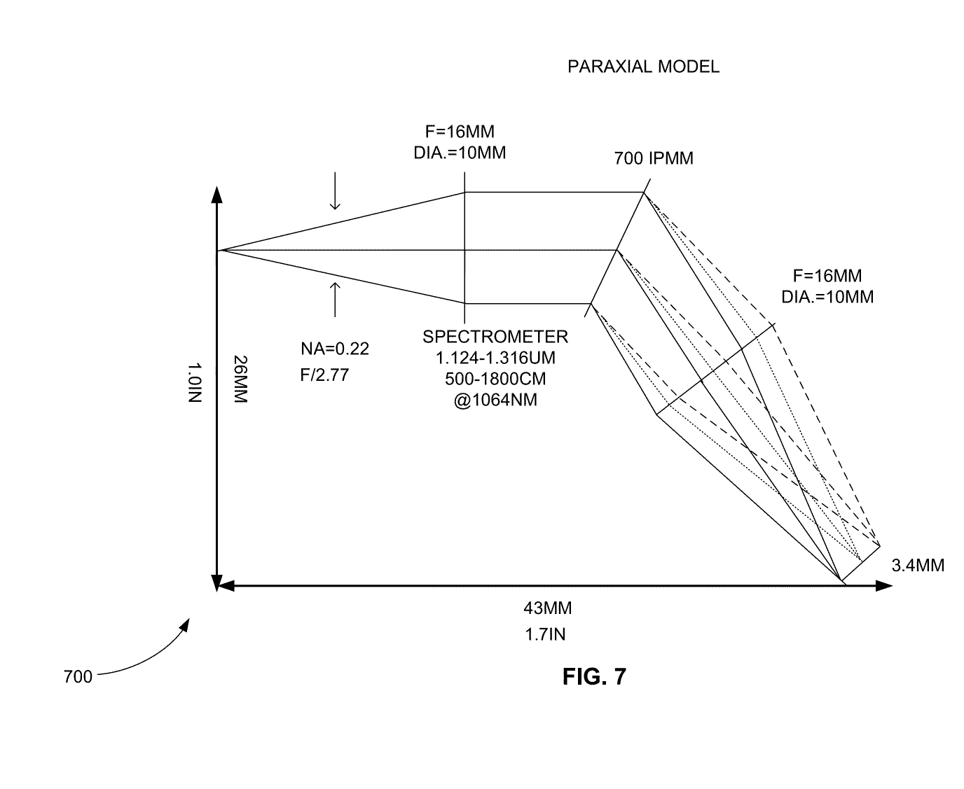

FIG. 7 is a schematic diagram of a paraxial model of the imaging spectrometer portion 700 of a handheld spectroscopy system for detecting unknown substances, in accordance with various embodiments. The paraxial model of imaging spectrometer portion 700 gives an idea of the size and the complexity of the design. Imaging spectrometer portion 700 disperses an image of the coded input and places this image on the coded mask at the output.

In various embodiments, the light from the coded mask at the output is collected and presented to a smaller single point diode with an active area diameter of about 2 mm, for example. This can be accomplished by an optical “circuit.” Many different optical circuits can be used. For example, an optical circuit that re-images the coded mask onto the detector (Abbe illumination) de-magnified by >1.8× can be used. Or, for example, an optical circuit that images the aperture stop of the system (Köhler illumination) onto the detector can be used. This illumination subsystem between the coded mask and the detector adds size, cost and complexity to the system, but is important to the design. Abbe illumination is able to reduce the detector size more than the Köhler method, but needs a more complicated lens structure to accomplish this in a small package. The Köhler method is easier to fit into a small package and is easier to align and focus than the Abbe method, but may need a larger detector size.

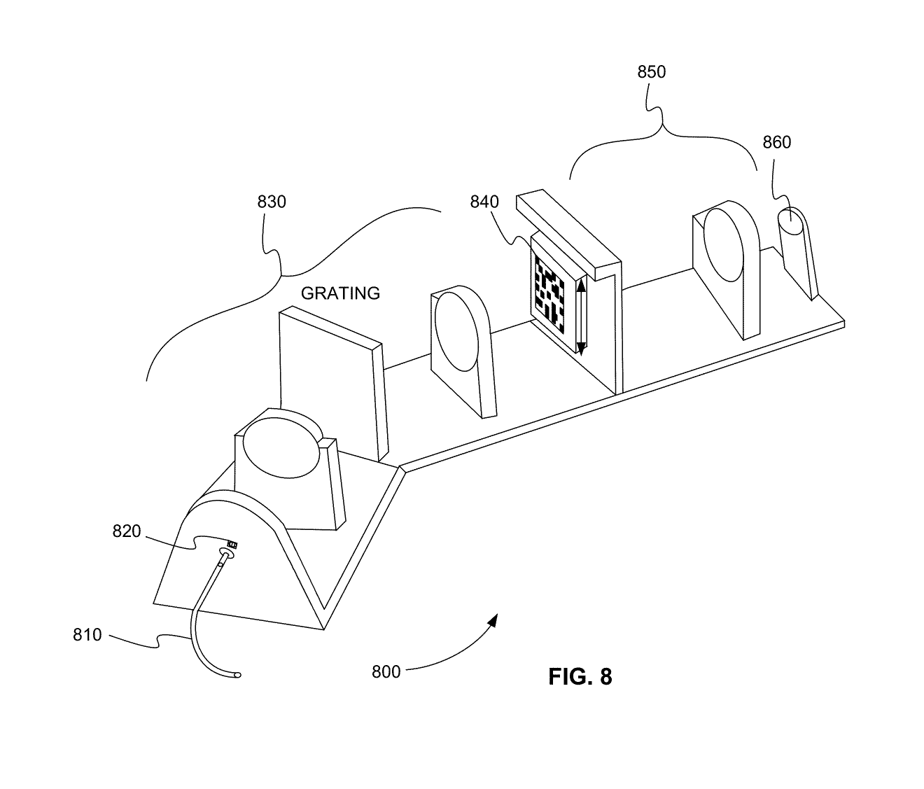

FIG. 8 is a schematic diagram of a handheld spectroscopy system 800 for detecting unknown substances, in accordance with various embodiments. System 800 includes fiber optic input 810, input coded mask 820, spectral imaging subsystem 830, output coded mask 840, output illumination subsystem 850, and point detector 860. Fiber optic input 810 receives light reflected from an unknown substance, for example. Input coded mask 820 encodes the light from fiber optic input 810. Spectral imaging subsystem 830 disperses the light from input coded mask 820 and images the dispersed light onto a row of output coded mask 840. Output coded mask 840, for example, moves vertically over time to expose additional rows of output coded mask 840 to the dispersed light. Encoded light from a row of output coded mask 840 is collected and fed to point detector 860 by illumination subsystem 850. Point detector 860 converts the encoded light into an electronic signature and can store the electronic signature in a memory (not shown). The electronic signature is, for example, digital data. This process is repeated for each row of output coded mask 840 until enough digital data is collected and stored in order to reconstruct the spectrum using a processor (not shown). A processor reconstructs a spectrum by solving a system of equations for the spectral channel unknowns, for example.

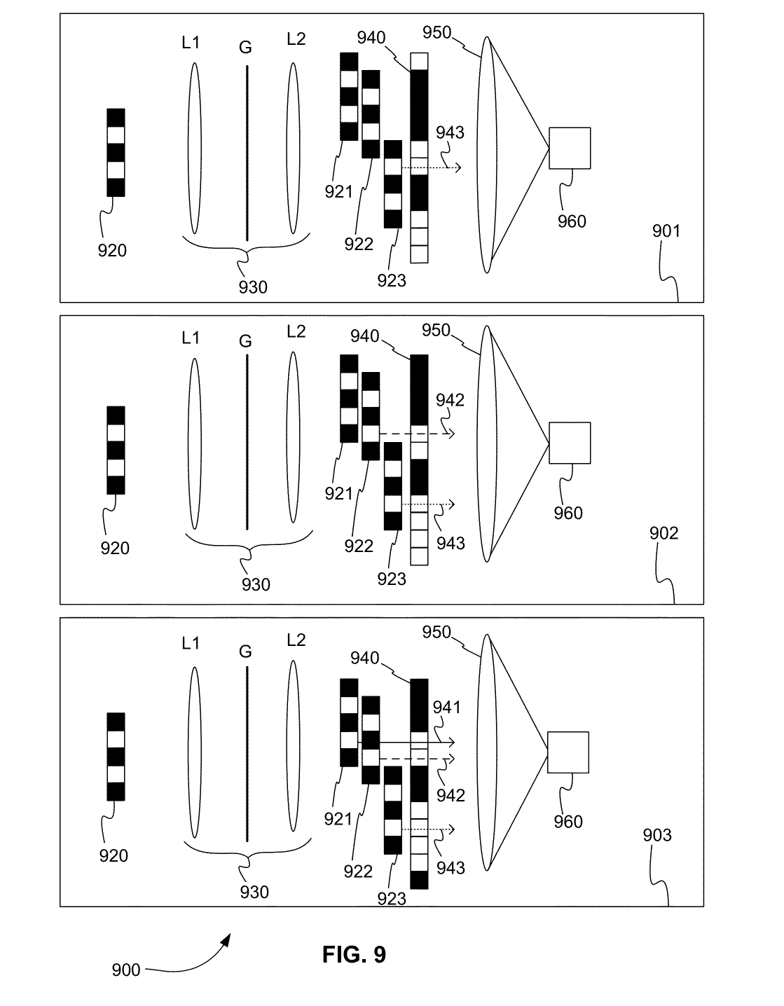

FIG. 9 is a schematic diagram showing a series 900 of measurements taken by a handheld spectroscopy system for detecting unknown substances as the output coded mask 940 is moved, in accordance with various embodiments. Series 900 includes measurements 901, 902, and 903. In measurements 901, 902, and 903, input coded mask 920 encodes the light received from a fiber optic input (not shown), and spectral imaging subsystem 930 disperses the light from input coded mask 920, producing blue, green, and red images, 921, 922, and 923, respectively, of input coded mask 920. Blue, green, and red images, 921, 922, and 923, of input coded mask 920 are incident on a row of output coded mask 940.

Output coded mask 940 is, for example, translated with respect to spectral imaging subsystem 930. This causes the row of output coded mask 940 receiving blue, green, and red images, 921, 922, and 923, to change in measurements 901, 902, and 903, respectively. Different rows of output coded mask 940 encode blue, green, and red images, 921, 922, and 923 differently. For example, the row of output coded mask 940 used in measurement 901 only transmits red signal 943 on to illumination subsystem 950 and point detector 960. The row of output coded mask 940 in measurement 902 transmits green signal 942 and red signal 943. The row of output coded mask 940 in measurement 903 transmits blue signal 941, green signal 942, and red signal 943.

In various embodiments, by knowing the codes of input coded mask 920 and output coded mask 940, a processor (not shown) can solve for blue signal 941, green signal 942, and red signal 943 using measurements 901, 902, and 903. For example, red signal 943 is measurement 901. Green signal 942 can then be found by subtracting measurement 901 from measurement 902. Finally, blue signal 941 is found by subtracting measurement 902 from measurement 903.

An exemplary handheld spectroscopy system built according to the specifications of FIG. 4 and the requirements of FIG. 5 needs approximately at least 170 scans (a position for each wavelength channel) to create a system of equations for an entire spectrum. Although the number of scans is large, using a coded mask system still has advantages over a system that simply scans a pinhole across the detector. For example, there are noise advantages to measuring the wavelengths together for each measurement. This advantage is the same as the Fellgett's multiplex advantage for Fourier transform-infrared (FT-IR) spectroscopy.

Unfortunately, however, the total scan time of this exemplary handheld spectroscopy system is approximately four times that of a conventional FT-Raman (at 1064 nm) system. This is due to the fact that light is only transmitted from 50% of the code in any one position and there are two codes (input and output). However, the scan time may be reduced by using one or more of the embodiments described below. Using one or more of these embodiments can reduce the total scan time of an exemplary handheld spectroscopy system to less than one minute, for example.

In various embodiments, the total scan time of an exemplary handheld spectroscopy is reduced using compressive sampling or compressed sensing. An underdetermined system of linear equations has more unknowns than equations and generally has an infinite number of solutions. However, if there is a unique sparse solution to the underdetermined system, then the compressive sampling framework allows the recovery of that solution (note: not all underdetermined systems of linear equations have a sparse solution, however).

Compressive sampling is a mathematical tool that creates a high resolution data set from low resolution samples. It is an iterative approach where the goal is to seek what's called sparsity (a measure of simplicity) of the data. In a handheld spectroscopy system the data is the sampled spectrum. If a processor of the handheld spectroscopy system is able to solve for one quarter of the equation produced by the input coded mask and the output coded mask, then compressive sampling can be used to fill in the blanks By taking this approach, total scan time can be reduced by a factor of four, which is approximately the total scan time needed for conventional FT-IR systems.

In various embodiments, the total scan time of an exemplary handheld spectroscopy system is reduced using prescreening. Prescreening takes advantage of the fact that the search space is finite. For example, if a handheld spectroscopy system is developed to look for only few target compounds, information about these target compounds can be used to reduce the total scan time. Information about these target compounds can include the fact that they have few distinct peaks that allow the target compounds to easily be distinguished. This information can then be used without having to reconstruct an entire spectrum.

For example, if one target compound has three distinct peaks, then a few initial scans can be used to sample the power in just these peak locations. If the measured signal is high enough, these initial scans can then provide enough certainty to determine the unknown compound without having to acquire any other data. Another way of thinking about this approach is that the data collected is prescreened with a series of matched filters for the target compounds. If any of these filters have large detected signals, then a match can quickly be found.

In various embodiments, the total scan time of an exemplary handheld spectroscopy system is reduced using adaptive data collection. Adaptive data collection is similar to the game twenty questions. An adaptive data collection algorithm adapts the next question to the one answered previously. Adaptive data collection can reduce the amount of time needed to acquire data and increase both sensitivity and selectivity. Adaptive data collection can include a method of geometric multi-resolution analysis (i.e., geometric wavelets) that can be used to minimize data collection steps. For spectral classification, this implies that <10 measurement steps with <100 mask codes may be sufficient.

In various embodiments, adaptive data collection includes using adaptable mask codes. As an alternative to moving or translating an output coded mask, liquid crystal spatial light modulators or digital mirror arrays can be used. These components add more complexity in the coded aperture subsystem, but can result in increased speed and accuracy.

### System for Identifying a Spectral Signature of an Unknown Substance

Returning to FIG. 8, system 800 can be used to identify a spectral signature of an unknown substance. An illumination source (not shown) directs illuminating light to an unknown compound (not shown). The illumination source produces illuminating light with a wavelength greater than 1000 microns to prevent fluorescence from affecting system 800, for example. Fiber optic input 810 receives the illuminating light reflected from the unknown compound.

Input coded mask 820 encodes the light received from the fiber optic input with a one-dimensional input code. Input coded mask 820 is a coded aperture fit onto a cross-section of the fiber optic input, for example. In various alternative embodiments, input coded mask 820 can be a slit. Spectral imaging subsystem 830 images input coded mask 820 and disperses the image.

Output coded mask 840 receives the dispersed image on a row of output coded mask 840. At each time step of a plurality of time steps, output coded mask 840 changes the code of the row to further encode the image on the row with a different additional one-dimensional code. Output coded mask 840 includes a coded aperture, for example. At each time step, output coded mask 840 changes the code of the row by moving the coded aperture. In various alternative embodiments, output coded mask 840 includes a liquid crystal spatial light modulator or a digital mirror array.

Illumination subsystem 850 collects the additionally encoded light from the row of output coded mask 840 at each time step. Illumination subsystem 850 collects the additionally encoded light at each time step using, for example, Abbe illumination or Köhler illumination. Point detector 860 receives the collected light from illumination subsystem 850 and converts the collected light to an electrical signal at each time step. Point detector 860 is, for example, an indium gallium arsenide (InGaAs) point detector. A memory (not shown) stores the electrical signal at each time step.

A processor (not shown) is in communication with the memory. The processor can be, but is not limited to, a computer, microprocessor, or any device capable of sending and receiving control signals and data and processing data. The processor receives the electrical signals stored for the plurality of time steps from the memory. The processor calculates a spectral signature for the unknown compound from the electrical signals stored for the plurality of time steps, the one-dimensional input code, and the different additional one-dimensional codes applied for the plurality of time steps. The spectral signature is, for example, a Raman spectral signature.

In various embodiments, the processor calculates a spectral signature for the unknown compound by creating a system of linear equations from the electrical signals stored for the plurality of time steps, the one-dimensional input code, and the different additional one-dimensional codes applied for the plurality of time steps, and solving the system of linear equations for the unknowns. If the system of linear equations is underdetermined, the processor, for example, uses compressive sampling to determine a unique sparse solution.

In various embodiments, the processor further compares the spectral signature to a plurality of spectral signatures of known compounds to identify the unknown compound. The processor can also be in communication with output coded mask 840, for example. The processor reduces how many times output coded mask 840 changes the code of the row by prescreening the electrical signals stored for the plurality of time steps using the plurality of spectral signatures of known compounds, for example.

In various embodiments, prescreening the electrical signals stored for the plurality of time steps can include creating a plurality of spectral filters for the plurality of spectral signatures, and comparing the plurality of spectral filters to the electrical signals stored for the plurality of time steps before collecting enough stored electrical signals to calculate the spectral signature.

In various embodiments, the processor can reduce how many times output coded mask 840 changes the code of the row by performing adaptive data collection. Adaptive data collection can include, for example, analyzing each electrical signal stored in the memory at the each time step and instructing output coded mask 840 to change a code of the row for a time step based on an electrical signal stored during a previous time step.

### Method for Identifying a Spectral Signature of an Unknown Substance

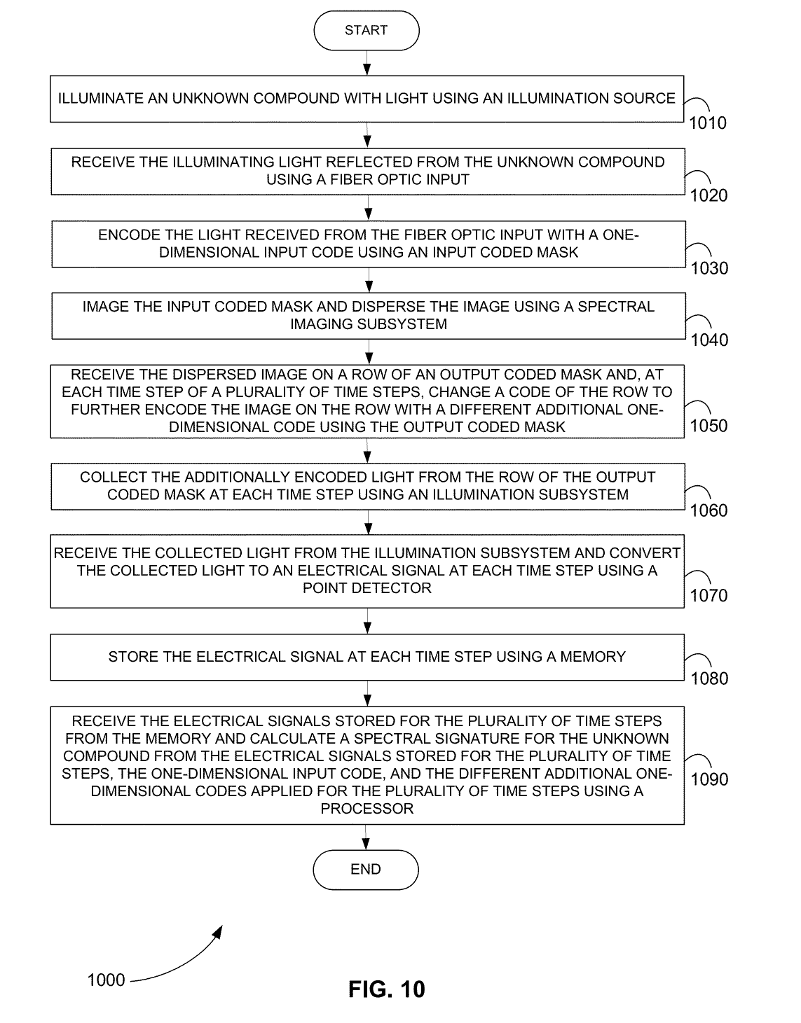

FIG. 10 is an exemplary flowchart showing a method 1000 for identifying a spectral signature of an unknown substance, in accordance with various embodiments.

In step 1010 of method 1000, an unknown compound is illuminated with light using an illumination source.

In step 1020, the illuminating light reflected from the unknown compound is received using a fiber optic input.

In step 1030, the light received from the fiber optic input is encoded with a one-dimensional input code using an input coded mask.

In step 1040, the input coded mask is imaged and the image is dispersed using a spectral imaging subsystem.

In step 1050, the dispersed image is received on a row of an output coded mask and, at each time step of a plurality of time steps, a code of the row is changed to further encode the image on the row with a different additional one-dimensional code using the output coded mask.

In step 1060, the additionally encoded light is collected from the row of the output coded mask at each time step using an illumination subsystem.

In step 1070, the collected light from the illumination subsystem is received and converted to an electrical signal at each time step using a point detector.

In step 1080, the electrical signal is stored at each time step using a memory.

In step 1090, the electrical signals stored for the plurality of time steps are received from the memory. A spectral signature for the unknown compound is calculated from the electrical signals stored for the plurality of time steps, the one-dimensional input code, and the different additional one-dimensional codes applied for the plurality of time steps using a processor.

### Computer Program Product for Identifying a Spectral Signature

In various embodiments, computer program products include a tangible computer-readable storage medium whose contents include a program with instructions being executed on a processor so as to perform a method for identifying a spectral signature of an unknown substance. This method is performed by a system that includes one or more distinct software modules.

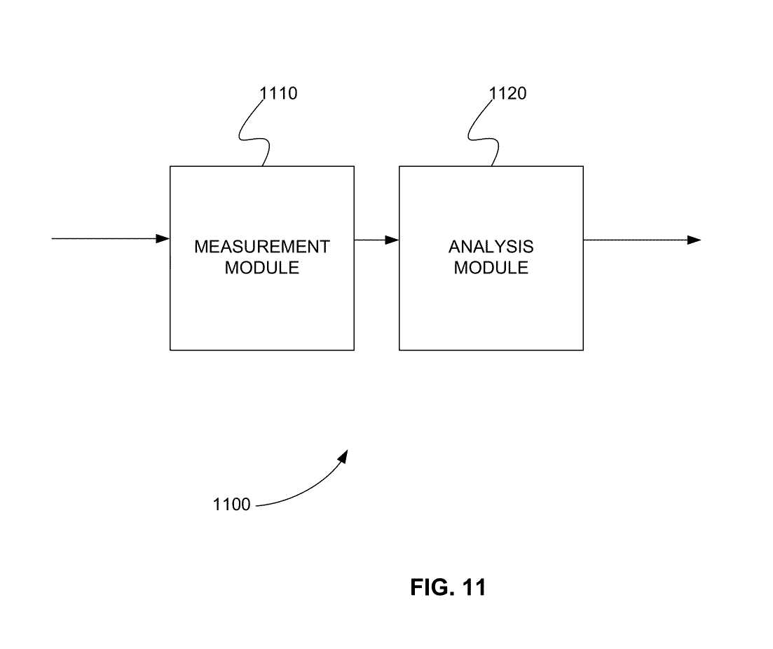

FIG. 11 is a schematic diagram of a system 1100 that includes one or more distinct software modules that performs a method for identifying a spectral signature of an unknown substance, in accordance with various embodiments. System 1100 includes measurement module 1110 and analysis module 1120.

Measurement module 1110 receives electrical signals stored for a plurality of time steps from a memory. An illumination source directs illuminating light to an unknown compound. A fiber optic input receives the illuminating light reflected from the unknown compound. An input coded mask encodes the light received from the fiber optic input with a one-dimensional input code. A spectral imaging subsystem images the input coded mask and disperses the image. An output coded mask receives the dispersed image on a row of the output coded mask. At each time step of the plurality of time steps, the output coded mask changes the code of the row to further encode the image on the row with a different additional one-dimensional code. An illumination subsystem collects the additionally encoded light from the row of the output coded mask at each time step. A point detector receives the collected light from the illumination subsystem and converts the collected light to an electrical signal at each time step. The memory stores the electrical signal at each time step.

Analysis module 1120 calculates a spectral signature for the unknown compound from the electrical signals stored for the plurality of time steps, the one-dimensional input code, and the different additional one-dimensional codes applied for the plurality of time steps.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for identifying a spectral signature of an unknown substance, comprising:
an illumination source that directs illuminating light to an unknown compound;
a fiber optic input that receives the illuminating light reflected from the unknown compound;
an input coded mask that encodes the light received from the fiber optic input with a one-dimensional input code;
a spectral imaging subsystem that images the input coded mask and disperses the image;
an output coded mask that receives the dispersed image on a row of the output coded mask and, at each time step of a plurality of time steps, changes a code of the row to further encode the image on the row with a different additional one-dimensional code;
an illumination subsystem that collects the additionally encoded light from the row of the output coded mask at the each time step;
a point detector that receives the collected light from the illumination subsystem and converts the collected light to an electrical signal at the each time step;
a memory that stores the electrical signal at the each time step; and
a processor that is in communication with the memory and that
receives the electrical signals stored for the plurality of time steps from the memory, and
calculates a spectral signature for the unknown compound from the electrical signals stored for the plurality of time steps, the one-dimensional input code, and the different additional one-dimensional codes applied for the plurality of time steps.

2. The system of claim 1, wherein the illuminating light comprises a wavelength greater than 1000 microns.

3. The system of claim 1, wherein the spectral signature comprises a Raman spectral signature.

4. The system of claim 1, wherein the input coded mask comprises a coded aperture fit onto a cross-section of the fiber optic input.

5. The system of claim 1, wherein output coded mask comprises a coded aperture.

6. The system of claim 5, wherein the output coded mask, at each time step of a plurality of time steps, changes the code of the row by moving the coded aperture.

7. The system of claim 1, wherein output coded mask comprises a liquid crystal spatial light modulator.

8. The system of claim 1, wherein output coded mask comprises a digital mirror array.

9. The system of claim 1, wherein the illumination subsystem collects the additionally encoded light from the row of the output coded mask at the each time step using Abbe illumination.

10. The system of claim 1, wherein the illumination subsystem collects the additionally encoded light from the row of the output coded mask at the each time step using Köhler illumination.

11. The system of claim 1, wherein the point detector comprises an indium gallium arsenide (InGaAs) point detector.

12. The system of claim 1, wherein the processor calculates a spectral signature for the unknown compound by creating a system of linear equations from the electrical signals stored for the plurality of time steps, the one-dimensional input code, and the different additional one-dimensional codes applied for the plurality of time steps, and solving the system of linear equations for unknowns.

13. The system of claim 13, wherein if the system of linear equations is underdetermined, the processor uses compressive sampling to determine a unique sparse solution.

14. The system of claim 1, wherein the processor further compares the spectral signature to a plurality of spectral signatures of known compounds to identify the unknown compound.

15. The system of claim 1, wherein the processor is further in communication with the output coded mask, and the processor reduces how many times the output coded mask changes the code of the row by prescreening the electrical signals stored for the plurality of time steps using the plurality of spectral signatures of known compounds.

16. The system of claim 15, wherein prescreening the electrical signals stored for the plurality of time steps using the plurality of spectral signatures of known compounds comprises
creating a plurality of spectral filters for the plurality of spectral signatures, and
comparing the plurality of spectral filters to the electrical signals stored for the plurality of time steps before collecting enough stored electrical signals to calculate the spectral signature.

17. The system of claim 1, wherein the processor is further in communication with the output coded mask, and the processor reduces how many times the output coded mask changes the code of the row by performing adaptive data collection.

18. The system of claim 1, wherein adaptive data collection comprises analyzing each electrical signal stored in the memory at the each time step and instructing the output coded mask to change a code of the row for a time step based on an electrical signal stored during a previous time step.

19. A method for identifying a spectral signature of an unknown substance, comprising:
illuminating an unknown compound with light using an illumination source;
receiving the illuminating light reflected from the unknown compound using a fiber optic input;
encoding the light received from the fiber optic input with a one-dimensional input code using an input coded mask;
imaging the input coded mask and dispersing the image using a spectral imaging subsystem;
receiving the dispersed image on a row of an output coded mask and, at each time step of a plurality of time steps, changing a code of the row to further encode the image on the row with a different additional one-dimensional code using the output coded mask;
collecting the additionally encoded light from the row of the output coded mask at the each time step using an illumination subsystem;
receiving the collected light from the illumination subsystem and converting the collected light to an electrical signal at the each time step using a point detector;
storing the electrical signal at the each time step using a memory; and
receiving the electrical signals stored for the plurality of time steps from the memory and calculating a spectral signature for the unknown compound from the electrical signals stored for the plurality of time steps, the one-dimensional input code, and the different additional one-dimensional codes applied for the plurality of time steps using a processor.

20. A computer program product, comprising a non-transitory and tangible computer-readable storage medium whose contents include a program with instructions being executed on a processor so as to perform a method for identifying a spectral signature of an unknown substance, the method comprising:
providing a system, wherein the system comprises one or more distinct software modules, and wherein the distinct software modules comprise a measurement module and an analysis module;
receiving electrical signals stored for a plurality of time steps from a memory using the measurement module, wherein an illumination source directs illuminating light to an unknown compound, a fiber optic input receives the illuminating light reflected from the unknown compound, an input coded mask encodes the light received from the fiber optic input with a one-dimensional input code, a spectral imaging subsystem images the input coded mask and disperses the image, an output coded mask receives the dispersed image on a row of the output coded mask and, at each time step of the plurality of time steps, changes a code of the row to further encode the image on the row with a different additional one-dimensional code, an illumination subsystem collects the additionally encoded light from the row of the output coded mask at the each time step, a point detector receives the collected light from the illumination subsystem and converts the collected light to an electrical signal at the each time step, and the memory stores the electrical signal at the each time step; and
calculating a spectral signature for the unknown compound from the electrical signals stored for the plurality of time steps, the one-dimensional input code, and the different additional one-dimensional codes applied for the plurality of time steps using the analysis module.
